(19) United States
(12) Patent Application Publication
(10) Pub. No.: US 2015/0087858 A1
(43) Pub. Date: Mar. 26, 2015

(54) CARBON NANOTUBE SUSPENSIONS AND METHODS OF MAKING THE SAME

(71) Applicant: Samsung SDI Co., Ltd., Yongin-si (KR)

(72) Inventors: Lijie Ci, Jinan Shandong (CN); Kuanping Gong, Fremont, CA (US)

(21) Appl. No.: 14/475,098

(22) Filed: Sep. 2, 2014

Related U.S. Application Data
(60) Provisional application No. 61/882,570, filed on Sep. 25, 2013.

(51) Int. Cl. C09D 11/52

(52) U.S. Cl. CPC C09D 11/52
USPC 562/89; 252/500

(57) ABSTRACT

Carbon nanotube suspensions or dispersions include carbon nanotubes and a functional group attached to an aromatic polycyclic compound on a surface of the carbon nanotubes. The carbon nanotubes in the suspensions or dispersions are pretreated by exposing the carbon nanotubes to a solvent (such as N-cyclohexyl-2-pyrrolidone) and an acid (such as concentrated sulfuric acid). The carbon nanotubes pretreated according to this method can be dispersed or suspended in a solvent to prepare high concentration suspensions, dispersions and/or inks for various applications.

### CROSS-REFERENCE TO RELATED APPLICATION(S)

This application claims the benefit of U.S. Provisional Patent Application Ser. No. 61/882,570, entitled CARBON NANOTUBE SUSPENSIONS AND METHODS OF MAKING THE SAME, filed on Sep. 25, 2013, the entire content of which is incorporated herein by reference.

### BACKGROUND

Carbon nanotubes have many unique properties, including, for example, being many-fold stronger than steel, harder than diamond, more electrically conductive than copper, more thermally conductive than diamond, etc. Due to these unique mechanical, physical and chemical properties, carbon nanotubes are used in a variety of applications. For example, carbon nanotube inks, i.e., carbon nanotube dispersions, are useful for direct printing of nanotube electronics and sensors. However, the unique morphology of carbon nanotubes makes it challenging to stably disperse them in a solvent. The nanotube surfaces are attracted to each other by molecular forces, and their high aspect ratios in combination with their flexibility dramatically increase their potential for entanglement, which leads to their precipitation out of the dispersion.

Techniques for dispersing carbon nanotubes have been actively pursued. Some techniques that are currently used include mechanical or chemical cutting, suspension in specific organic solvents or superacids, dispersion with the aid of surfactants or dispersants, and covalent modification. Mechanical or chemical cutting techniques cut carbon nanotubes into fragments using mechanical force, chemical oxidation, or both. Examples of such processes include ultrasonication, ball-milling, homogenization (e.g., using homogenizers) and rotor-stator type mixing in the presence or absence of an oxidizing agent. Although shorter nanotubes are easier to disperse, cutting CNTs into shorter counterparts inevitably alters their properties, such as electrical conductivity, mechanical stability, and chemical activity, which are determined by the size, length and aspect ratio of the CNTs. Furthermore, cutting the CNTs allows external mechanical and/or chemical invasion, which consumes a significant amount of the CNTs. This invasion causes defects in the sidewalls and tips of the CNTs, for example dangling bonds, oxygen-containing groups, and vacancies. These defects often invade the conjugated backbone of the CNTs and degrade their electrical conductivity.

Dispersion or suspension of the CNTs in specific organic solvents or superacids also has limitations. For example, the solvents and superacids commonly used to disperse CNTs (such as, for example, dimethylformamide, chloroform, dichlorobenzene, N-methyl-2-pyrrolidone and chlorosulfonic acid) are typically environmentally malignant, corrosive, and have high boiling points. These features complicate the solvent-based processing of CNTs for industrial applications. Such concerns are particularly problematic for flexible CNT-based electronics, since solvents of this kind are often incompatible with the plastic and polymeric film substrates widely used in these applications.

Dispersion or suspension of CNTs with the aid of surfactants, dispersants or additives typically utilizes chemicals with dual functional groups, i.e., a tail group that can attach strongly to the nanotubes' sidewalls via a hydrophobic and/or van der Waals interaction, and a head group that is hydrophilic or charged and therefore allows nanotubes to be dispersed in solvents by electrostatic and steric repulsion. Commonly used chemicals for this purpose include sodium dodecyl sulfate (SDS), lithium dodecyl sulfate (LDS), tetradecyl trimethyl ammonium bromide (TTAB), sodium chlorate, polysaccharides, cellulose derivatives, and bio-macromolecules such as DNA and peptides. However, such non-covalent modification of the CNTs suppresses their unique benefits, such as high electrical conductivity. Due to the strong adsorptive interaction between CNTs and these additives, this method requires additional steps in the processing of the CNTs, i.e., removal of the additives to recover the intrinsic nature of the CNTs, but even after the removal process, some residual additives will remain, which may degrade the performance of certain CNT-based devices that involve sensitive surface chemistry.

Methods for covalent modification of CNTs include sulfonation, halogenation, carboxylation, polymerization or diazotization, which irreversibly alter the conjugated crystalline structure of the CNTs through chemical modification. CNTs modified in this way often suffer from low conductivity, and the modifying chemicals may impede electron transfer and mass diffusion in heterogeneous reactions involving CNTs. Additionally, due to the intrinsically insufficient dispersibility of CNTs, they tend to entangle to form bundles and skeins, yielding smaller contact areas with the modifying chemicals. This significantly limits the efficiency of the covalent modification techniques.

### SUMMARY

According to embodiments of the present invention, a method of pretreating carbon nanotubes includes immersing or dispersing the carbon nanotubes in N-cyclohexyl-2-pyrrolidone (CHP) and mixing the carbon nanotubes in concentrated sulfuric acid. As used herein, the term “concentrated sulfuric acid” is used in its art-recognized sense to refer to sulfuric acid that has been concentrated to a concentration of about 98% or greater. In some embodiments, the pretreatment may include a one-step process in which the carbon nanotubes, CHP and concentrated sulfuric acid are mixed to form a solution. The solution may be mixed by tip sonication, and the solution may be heated to further facilitate the pretreatment reaction. Alternatively, the pretreatment may include a two-step process in which the CNTs are first dispersed or immersed in CHP, and then added to the concentrated sulfuric acid. The resulting solution of CHP, CNTs and concentrated sulfuric acid may be mixed by tip sonication. Also, the initial solution of CNTs and CHP may be heated, and/or the final solution of CNTs, CHP and concentrated sulfuric acid may be heated to further facilitate the pretreatment reaction.

The method may further include removing the CNTs from the solution of CHP and concentrated sulfuric acid by, for example, filtration. The CNTs removed from the solution may then be dried using any suitable drying technique. CNTs pretreated in this manner include —SO₃H functional groups on aromatic polycyclic compounds on the surfaces of the CNTs. However, the underlying CNTs themselves remain substantially unmodified, and their characteristics (including, for example, electrical conductivity) remain substantially unchanged (in comparison to corresponding untreated, raw or pristine CNTs).

According to other embodiments of the present invention, carbon nanotube dispersions, suspensions or inks include the pretreated carbon nanotubes dispersed or suspended in a solvent. The pretreated carbon nanotubes in the dispersions are pretreated according to one of the methods for pretreating carbon nanotubes discussed above. The pretreatment results in carbon nanotubes having functional groups on aromatic polycyclic compounds on the surfaces of the CNTs. In some embodiments, the surface functional groups include —SO₃H groups attached to aromatic polycyclic compounds on the surfaces of the CNTs. According to some embodiments of the present invention, a carbon nanotube ink, dispersion or suspension includes surface functionalized carbon nanotubes dispersed or suspended in a solvent. As used herein, the term “surface functionalized carbon nanotubes” refers to carbon nanotubes which have functional groups attached to aromatic polycyclic compounds on the surfaces of the carbon nanotubes, but which do not include chemical modifications to the underlying carbon nanotubes themselves.

In some embodiments, the solvent in the carbon nanotube dispersions, suspensions or inks may be water, ethanol, dimethylformamide (DMF), or propylene carbonate (PC). As noted above, the pretreatment process enables the manufacture of high concentration dispersions, suspensions or inks of carbon nanotubes. In some embodiments, for example, a dispersion of pretreated CNTs in water can have a concentration of about 0.1 mg/mL to about 0.3 mg/mL. In other exemplary embodiments, a dispersion of pretreated CNTs in propylene carbonate can have a concentration of about 0.1 mg/mL to about 0.5 mg/mL. In some other embodiments, a dispersion of pretreated CNTs in ethanol can have a concentration of about 0.1 mg/ml to about 0.5 mg/ml. In yet other embodiments, dispersions of CNTs having a length of about 10 to about 20 microns in pyrrolidinone derivatives (e.g., N-butyl-pyrrolidinone, N-methyl-pyrrolidinone, and N-octyl-pyrrolidinone) can have concentrations up to about 10 mg/ml.

In other embodiments, a method of preparing a carbon nanotube dispersion, suspension or ink includes pretreating carbon nanotubes with CHP and concentrated sulfuric acid as discussed above, and dispersing the pretreated carbon nanotubes in a solvent. In some embodiments, dispersing the pretreated carbon nanotubes may be accomplished by tip sonication.

The methods of pretreating carbon nanotubes and preparing carbon nanotube dispersions, suspensions or inks according to embodiments of the present invention enable the manufacture of high concentration carbon nanotube dispersions, suspensions or inks without the need for other additives. Additionally, the pretreatment processes according to embodiments of the present invention enable the preparation of high concentration dispersions without significantly or substantially changing the morphology or characteristics of the underlying carbon nanotubes.

### BRIEF DESCRIPTION OF THE DRAWINGS

The features and advantages of embodiments of the present invention will be better understood by reference to the following detailed description when considered in conjunction with the accompanying drawings, in which:

FIG. 1 is a schematic illustration of a pretreatment procedure according to an embodiment of the present invention;

FIG. 2 is a digital photograph of a dispersion of pristine CNTs in water (left), a dispersion of CNTs pretreated according to an embodiment of the present invention dispersed in water (middle), and a dispersion of CNTs pretreated according to an embodiment of the present invention and dispersed in propylene carbonate (right);

FIG. 3a is a digital photograph of pristine double walled carbon nanotubes (DWNTs);

FIG. 3b is a digital photograph of a suspension of the DWNTs of FIG. 3A in water prepared by tip-sonication for 45 minutes;

FIG. 3c is a digital photograph of a suspension of the DWNTs of FIG. 3A in ethanol prepared by tip-sonication for 45 minutes;

FIG. 3d is a digital photograph of a suspension of the DWNTs of FIG. 3A in propylene carbonate prepared by tip-sonication for 45 minutes;

FIG. 4 is a digital photograph of various suspensions of DWNTs pre-treated according to an embodiment of the present invention: suspension in water prepared by tip-sonication for 45 minutes (left); suspension in ethanol prepared by tip-sonication for 45 minutes (middle); and suspension in propylene carbonate prepared by tip-sonication for 45 minutes (right);

FIG. 5a is a scanning electron microscope (SEM) image of DWNTs prepared according to Comparative Example C and pretreated according to an embodiment of the present invention;

FIG. 5b is a transmission electron microscope (TEM) image of DWNTs prepared according to Comparative Example C and pretreated according to an embodiment of the present invention;

FIG. 5c is a scanning electron microscope (SEM) image (at the same magnification as FIG. 5a) of untreated DWNTs prepared according to Comparative Example C;

FIG. 5d is a transmission electron microscope (TEM) image (at the same magnification as FIG. 5b) of untreated DWNTs prepared according to Comparative Example C;

FIG. 6 is a graph comparing the Raman spectra of untreated DWNTs (top) and DWNTs pretreated according to an embodiment of the present invention (bottom);

FIG. 7a is a digital photograph of the untreated CNTs prepared according to Example 1 immersed in toluene;

FIG. 7b is a digital photograph of the solution of FIG. 7a after filtering out the CNTs;

FIG. 8 depicts a gas chromatography-mass spectrometry (GC-MS) spectrum of the filtrate solution of FIG. 7b (top left and top right), and two database GC-MS spectra from the GC-MS database showing a greater than 81% match with the spectrum of the filtrate solution of FIG. 7b determined based on identification of the primary peak;

FIG. 9 is a Raman spectrum of the residue from the filtrate solution of FIG. 7b after removal of the toluene by rotary vaporization;

FIG. 10 is a UV-vis spectrum of commercially available CNTs showing the existence of aromatic polycyclic compounds on the surfaces of the CNTs; and

FIG. 11 is a TEM image of the commercially available CNTs used in FIG. 10 showing the existence of aromatic polycyclic compounds on the surfaces of the CNTs.

### DETAILED DESCRIPTION

Carbon nanotubes (either single-walled carbon nanotubes (SWNTs) or multi-walled nanotubes (MWNTs, including double-walled carbon nanotubes)) can be synthesized using various techniques, for example, arc discharge, laser ablation, plasma torch, and chemical vapor deposition (CVD). Despite the different methods used to prepare CNTs, a certain amount of carbonaceous materials with low crystallinity, such as polycyclic compounds and amorphous carbon, remain attached to the outer walls of the CNTs. Indeed, as a result of the incomplete pyrolysis of carbon sources during the synthesis of carbon nanotubes (CNTs), a layer of aromatic compounds, particularly aromatic polycyclic compounds (APCs) remain at the surface of the CNTs. In some embodiments of the present invention, these APCs at the surface of the carbon nanotubes are modified through functionalization (e.g., sulfonation) of the APCs attached to the surface of the carbon nanotubes. This surface modification enables the stable suspension or dispersion of high concentrations of carbon nanotubes in various solvents. As used herein, the term “stable dispersion” and similar terms refers to a dispersion of CNTs in which the CNTs remain substantially dispersed in the solvent, and generally do not precipitate out of the solvent over an extended period of time. Indeed, the suspensions according to embodiments of the present invention are dynamically stable systems, and the CNTs remain substantially suspended in the solvent. As noted below in the Examples, the suspensions made according to the Examples have remained substantially suspended in solution for over 3 months (i.e., with no observable sedimentation after two weeks, and only an insignificant amount of sedimentation observed after three months). After three months, the suspensions remained substantially uniformly black in color, evidencing dynamically stable systems.

Accordingly, in some embodiments of the present invention, suspensions of carbon nanotubes include surface modified carbon nanotubes suspended (or dispersed) in a solvent. As used herein, the term “surface functionalized carbon nanotubes,” and similar terms, refers to carbon nanotubes which have functional groups attached to aromatic polycyclic compounds on the surfaces of the carbon nanotubes, but which do not include chemical modifications to the underlying carbon nanotubes themselves.

As used herein, the terms “aromatic polycyclic compounds (APCs)” and “polycyclic aromatic compounds (PACs)” are used interchangeably to refer to the polycyclic compounds on the surface of the raw (i.e., untreated) carbon nanotubes, and both terms (and similar terms) refer to polycyclic aromatic compounds as well as amorphous compounds. Additionally, as used herein, the terms “dispersion” and “suspension,” and similar terms, are used interchangeably to refer to a solution of nanotubes in solvent in which the nanotubes are dispersed (or suspended) in the solvent.

In some embodiments of the present invention, the surface modified carbon nanotubes are carbon nanotubes pretreated according to the methods described herein. For example, the surface modification of the carbon nano tubes may include functionalization (e.g., sulfonation) of the APCs on the surfaces of the CNTs, as described in more detail herein. In particular, in some embodiments, the APCs attached to the outside walls of the CNTs may be modified to form functionalized (e.g., sulfonated) APCs (e.g., APC—SO₃)). Due to hydrophobic interactions, a sulfonated APC has one end strongly attached to the carbon nanotubes, while the other end is functionalized with the sulfonate group.

The solvent in the dispersion or suspension (also referred to herein, interchangeably, as an ink) of the CNTs should be stable enough for storage and transportation, and capable of suspending (or dispersing) high concentrations of carbon nanotubes. In addition, the solvent should be inert (i.e., not reactive with the carbon nanotubes, or any substrate intended to be printed with the ink), and fast drying upon printing. Some nonlimiting examples of classes of solvents that can be used to suspend the pre-treated CNTs include polar aprotic solvents, polar protic solvents, and non-polar solvents. Nonlimiting examples of suitable polar aprotic solvents include pyrrolidone derivatives, which can be used to prepare relatively high concentration CNT inks. A nonlimiting example of a non-polar solvent is hexane, which may yield a relatively low concentration CNT ink. Additionally, a mixture of solvents may be used to enhance or improve dispersability of the CNTs. For example, in some embodiments, the —SO₃H terminal of the APCs may be used for a phase transfer of CNTs to the non-polar solvent using a phase transfer catalyst.

For example, the solvent can be any suitable solvent for making CNT inks, including, but not limited to, organic or aqueous solvents, such as, for example, water, chloroform, chlorobenzene, acetic acid, acetone, acetonitrile, aniline, benzene, benzonitrile, benzyl alcohol, bromobenzene, bromoform, 1-butanol, 2-butanol, carbon disulfide, carbon tetrachloride, cyclohexane, cyclohexanol, decalin, dibromoethane, diethylene glycol, diethylene glycol ethers, diethyl ether, diglyme, dimethoxymethane, N,N-dimethylformamide, ethanol, ethylamine, ethyl benzene, ethylene glycol ethers, ethylene glycol, ethylene glycol acetates, propylene glycol, propylene glycol acetates, ethylene oxide, formaldehyde, formic acid, glycerol, heptane, hexane, iodobenzene, mesitylene, methanol, methoxybenzene, methylamine, methylene bromide, methylene chloride, methylpyridine, morpholine, naphthalene, nitrobenzene, nitromethane, octane, pentane, pentyl alcohol, phenol, 1-propanol, 2-propanol, terpineol, texanol, carbitol, carbitol acetate, butyl carbitol acetate, dibasic ester, propylene carbonate, pyridine, pyrrole, pyrrolidone, quinoline, 1,1,2,2-tetrachloroethane, tetrachloroethylene, tetrahydrofuran, tetrahydropyran, tetralin, tetra methylethylenediamine, thiophene, toluene, 1,2,4-trichlorobenzene, 1,1,1-trichloroethane, 1,1,2-trichloroethane, trichloroethylene, triethylamine, triethylene glycol dimethyl ether, 1,3,5-trimethylbenzene, m-xylene, o-xylene, p-xylene, 1,2-dichlorobenzene, 1,3-dichlorobenzene, 1,4-dichlorobenzene, 1,2-dichloroethane, N-methyl-2-pyrrolidone, methyl ethyl ketone, dioxane, or dimethyl sulfoxide. Halogenated organic solvents may also be used, such as, for example, 1,1,2,2-tetrachloroethane, chlorobenzene, chloroform, methylene chloride, 1,2-dichloroethane or chlorobenzene. For example, in some embodiments, the solvent in the dispersion may be water, ethanol, propylene carbonate, or dimethyl formamide (DMF).

Additionally, the surface functionalization of the carbon nanotubes according to embodiments of the present invention enables the CNTs to be dispersed in more environmentally friendly, less corrosive solvents with lower boiling points. Nonlimiting examples of such solvents include water, ethanol, acetone, and propylene carbonate. For example, in some embodiments, the solvent in the dispersion is water, ethanol or propylene carbonate. According to some embodiments of the present invention, dispersions of the pretreated CNTs in non-invasive solvents, such as water or ethanol, can be used in applications requiring compatibility of the solvent with the substrate (e.g., plastic electronics, transparent conductors, solar electrodes, current collectors, etc.) or in applications requiring compatibility of the solvent with a system or separator membrane (e.g., electrodes for fuel cells, supercapacitors, batteries, etc.). In other embodiments, dispersions of the pretreated CNTs in superacids, such as chlorosulfuric acid or tirfluoromethanesulfonic acid, can be used to manufacture carbon fibers or conductive glasses. In still other embodiments, dispersions of the pretreated CNTs in organic solvents, such as CHP, dimethylformamide (DMF) or toluene, can be used to manufacture CNT-based composites (such as porous filter membranes, conductive plastics, or separators for fuel cells, supercapacitors or batteries).

The surface functionalization of the CNTs as a result of the pretreatment processes according to embodiments of the present invention also enables to manufacture of stable dispersions or suspensions with higher concentrations of CNTs. Conventional CNT dispersions typically have a concentration of 0.1 mg/mL. According to embodiments of the present invention, however, the CNT dispersions including the surface functionalized CNTs can reach much higher concentrations in a given solvent at room temperature. For example, in some embodiments, ultra-long DWNTs (e.g., DWNTs with an average length up to about a mm long) can be dispersed uniformly in propylene carbonate at a concentration up to 0.5 mg/mL without the help of any surfactants or other additives. In some embodiments, the addition of a polymer gel (e.g., a polymer/DMF gel) can increase the concentration of CNTs in the suspension. For example, with the help of a polymer/DMF gel, ultra-long DWNTs (e.g., those with an average length of up to about a mm) can be dispersed uniformly in propylene carbonate at a concentration up to about 1.0 w/w %. In other examples, ultra-long DWNTs (e.g., those with an average length of up to about a mm) can be dispersed uniformly in water or ethanol at a concentration up to 0.3 mg/mL without the help of any surfactants or other additives. In some embodiments, with the help of a polymer gel (e.g., a polymer/DMF gel), ultra-long DWNTs (e.g., those with an average length of up to about a mm) can be dispersed uniformly in water or ethanol at a concentration up to about 0.2 w/w %.

Any CNTs can be chemically modified by the techniques according to embodiments of the present invention in order to improve the dispersibility of the CNTs. For example, the CNTs may be multi-walled, single-walled or double-walled, and may have any length and aspect ratio. In some embodiments, for example, the CNTs may be multi-walled, single-walled or double-walled nanotubes having a length of about 0.5 to about 20 microns.

The dispersions or suspensions of CNTs pretreated according to embodiments of the present invention are stable (i.e., the CNTs generally do not precipitate out of the suspension) without the need to include additional additives, or the like. However, in some embodiments, the addition of certain additives may still be desirable. For example, additives might be desired to adjust the viscosity, pigment, or foaming of the suspension to make the suspension suitable for a particular application. Also, additives can help assembly, alignment and/or attachment of CNTs by giving them a charge, further disentangling them into individual nanotubes or smaller bundles, and/or adjusting their affinity to water or lipids. Accordingly, in some embodiments, the carbon nanotube inks (i.e., dispersions or suspensions) may further include additives, such as viscosity modifiers, pigments, defoamers, etc. Viscosity modifiers are chemical compounds capable of modifying the viscosity of the carbon nanotube ink, which may be necessary or desirable to enable printing or jetting or to make printing or jetting easier. Nonlimiting examples of suitable viscosity modifiers include glycerol. Pigments can be used to impart opacity or similar properties to the inks. Nonlimiting examples of suitable pigments include TiO₂, CaCO₃, SiO₂ and the like. Defoamers may be used to reduce the amount of foam in the ink. Nonlimiting examples of suitable defoamers include nonionic compounds, such as diols, linear alcohols or non-polar compounds.

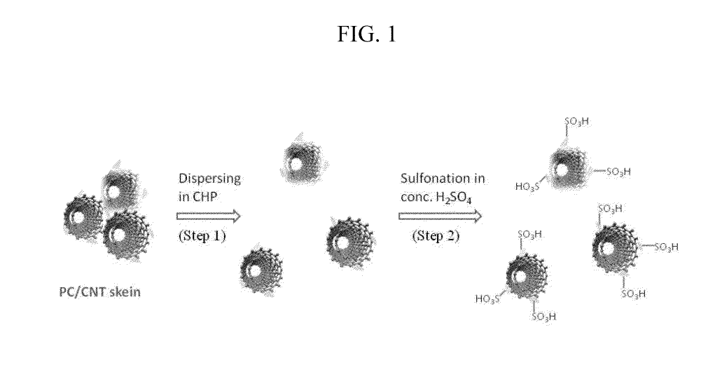

As discussed above, the carbon nanotubes in the dispersions (or suspensions) are surface functionalized with sulfonate groups. In some embodiments of the present invention, raw carbon nanotubes (e.g., commercially available CNTs from, for example, Cheap Tubes, Inc., American Elements®, SouthWest Nano Technologies, Shenzhen Nanotech Port Co., Ltd. and Molecular Nanosystems, Inc.), or untreated and unpurified CNTs grown by any known method, for example, but not limited to floating catalyst chemical vapor deposition (FCCVD)) are surface functionalized by subjecting them to a pretreatment process that includes two chemicals. One of the chemicals is N-cyclohexyl-2-pyrrolidone (CHP), in which the raw CNTs are immersed, dispersed or suspended. In some embodiments, in place of the CHP, a CHP analogue, N,N-dimethyl formamide, dimethyl sulfoxide, methylpyridine, tetrahydrofuran, or the like may be used. Nonlimiting examples of suitable CHP analogues include dimethyl-tetrahydro-2-pyrimidinone, N-butyl-pyrrolidinone, benzyl-pyrrolidinone, N-methyl-pyrrolidinone, 3-(2-oxo-1-pyrrolidinyl)propanenitrile, N-ethyl-pyrrolidinone, N-octyl-pyrrolidinone, N-vinyl-pyrrolidinone, dimethyl-imidazolidinone, dimethyl-acetamide and N-dodecyl-pyrrolidone. The second chemical is concentrated sulfuric acid (H₂SO₄), with which the raw CNTs are mixed. In some embodiments, as shown in FIG. 1, the CNTs are first dispersed in the CHP, and then the CHP/CNT dispersion is mixed with concentrated sulfuric acid (H₂SO₄) at an elevated temperature. In some embodiments, in place of the concentrated sulfuric acid, chlorosulfuric acid or oleum (i.e., H₂SO₄+20% SO₃) may be used. In some embodiments, the elevated temperature may be about 50° C. to about 200° C. This process installs sulfonate groups on the APCs on the surfaces of the CNTs. The surface functionalized carbon nanotubes may then be rinsed and dried to substantially remove the solvent. As used herein, the term “substantially” is used as a term of approximation, and not as a term of degree. In particular, as used herein, “substantially remove the solvent” refers to the removal of most of the solvent from the treated CNTs, but that some trace amounts of the solvent may remain after the removal process. The carbon nanotubes pretreated in this manner can be stably dispersed in various solvents (e.g., water, ethanol, dimethylformamide (DMF), propylene carbonate (PC), etc.) to form stable dispersions or suspensions, as discussed above.

Tip-sonication may be used to disperse the raw CNTs in the CHP during the pretreatment process. The tip-sonication can be performed for any suitable amount of time until the desired dispersion is achieved. In some embodiments, for example, the CNTs are tip-sonicated in the CHP for about 10 minutes to about 1 hour (depending on the size and amount of the CNTs) to prepare a suitable dispersion of the CNTs in the CHP. For example, in some embodiments, the CNTs are tip-sonicated in the CHP for about 30 minutes to prepare a suitable dispersion of CNTs in the CHP Other suitable dispersion techniques (other than tip-sonication) include bath sonication, stirring and shaking. Indeed, any dispersion technique capable of wetting and dispersing the CNTs for efficient contact with the concentrated sulfuric acid may be used.

The dispersion of CNTs in CHP may then be added to the concentrated sulfuric acid. This concentrated sulfuric acid treatment can be conducted at elevated temperature. In some embodiments, the sulfuric acid treatment is conducted at a temperature of about 50° C. to about 200° C. for about 1 hour to about 150 hours (depending on the amount and distribution of the APCs in the CNT samples to be treated). For example, in some embodiments, the sulfuric acid treatment is conducted at about 85° C. for about 24 hours. Any suitable mixing means may be used to facilitate the treatment. For example, stir bars can be utilized. The CHP and sulfuric acid can be used in any suitable ratio (even pure sulfuric acid), and the amount of the CNTs can be any amount, and may be as high as possible as long as the mixture appears to be fluid and not a carbon paste.

As noted above, according to some embodiments of the present invention, the raw CNTs (which include PACs on the surfaces of the CNTs) are first immersed in CHP, which serves to de-bundle the CNTs and disperse them in the CHP. The PACs on the surfaces of the CNTs are then sulfonated by mixing the CHP/CNT dispersion with concentrated H₂SO₄, which installs hydrophilic functional groups (i.e., —SO₃H groups) on the surfaces of the CNTs by reaction with the APCs on the surfaces of the CNTs. This pretreatment process yields CNTs with improved dispersibility in various solvents, including water and various organic solvents.

However, the pretreatment process is not limited to a two-step process, and the pretreatment process can be conducted in one step. In such an embodiment, the CNTs, CHP and concentrated sulfuric acid are mixed together at the same time, and then heated at the same temperature described above with respect to the two-step process. The one-step process can also include heating the mixture over the same duration as described above for the two-step process. However, in some embodiments, the one-step process includes a longer heating period. For example, in some embodiments, the one-step process may include a heating period that is about 4 hours longer than the heating period used in the two step process. In particular, in some embodiments, the heating period used in the one step process may be about 1 hour to about 200 hours (depending on the amount and distribution of APCs in the CNT samples to be treated).

The following Examples A-C and Comparative Example A illustrate certain exemplary dispersions and processes. However, it is understood that these Examples are presented for illustrative purposes only, and do not limit the scope of the present invention.

### Example A

### Two-Step Process

200 mg of double-walled CNTs with a length of about 3 to 30 μm (supplied by CheapTubes, Inc) were first mixed with 100 ml CHP and the mixture was tip-sonicated for about 30 minutes to obtain a CNT/CHP suspension. Next, the CNT/CHP suspension was mixed with 200 ml of 98% H₂SO₄. The mixture was heated at 85° C. and stirred with a magnetic stirrer for 24 hours.

### Example B

### One-Step Process

200 mg of double-walled CNTs with a length of about 3 to 30 μm (supplied by Cheap Tubes, Inc), 100 ml of CHP, and 200 ml of 98% H₂SO₄ were mixed in a glass beaker. The mixture was then heated at 85° C. and stirred with a magnetic stirrer for 24 hours.

To compare the dispersibility of the CNTs prepared according to Examples 1 (two-step process) and 2 (one-step process), the heat-treated mixtures of Examples 1 and 2 were each separated by centrifuge and filtered to isolate the pretreated CNTs. The CNTs were then rinsed with copious amounts of water, and then dried in air at ambient temperature. Each of the obtained CNT samples was then used to prepare dispersions in water (Example A (two-step sample): 0.2 mg/ml in water; Example B (one-step sample): 0.15 mg/ml in water) and dispersions in propylene carbonate (PC)(Example A (two-step sample): 0.25 mg/ml in PC; Example B (one-step sample): 0.15 mg/ml in PC).

To determine the effect of heat-treatment duration on the dispersibility of CNTs pretreated by a one-step process, Example C was prepared.

### Example C

### One-Step Process

Pretreated CNTs were prepared as in Example B, except that the mixture was heated at 85° C. for 28 hours instead of 24 hours.

As can be seen from a comparison of Examples A and B, both the two-step and one-step processes provide stable dispersions of CNTs. However, the comparison of Examples A and B also shows that the one-step process (Example B) is somewhat less efficient than the two-step process (Example A). As shown in Example C, however, extending the heating time by about 4 hours in the one-step process results in solubility (or dispersibility) of the CNTs that is comparable to that achieved by the two-step process.

To confirm that CNTs pretreated according to embodiments of the present invention have significantly improved dispersibility, Comparative Examples A and B (below) were prepared.

### Comparative Example A

5 mg of double-walled CNTs with a length of about 3 to 30 μm (supplied by CheapTubes, Inc) were added to 50 ml of water and the mixture was tip-sonicated for 30 minutes.

### Comparative Example B

5 mg of double-walled CNTs with a length of about 3 to 30 μm (supplied by CheapTubes, Inc) were added to 50 ml of propylene carbonate and the mixture was tip-sonicated for 30 minutes.

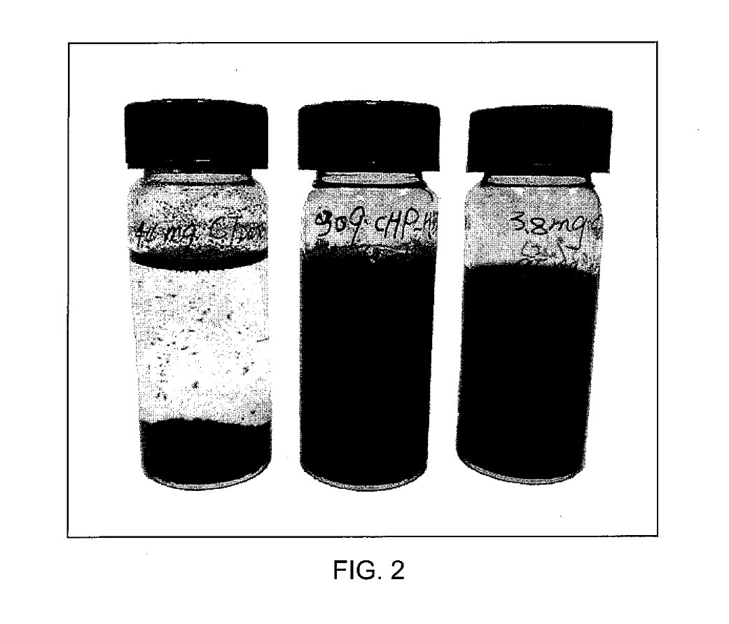

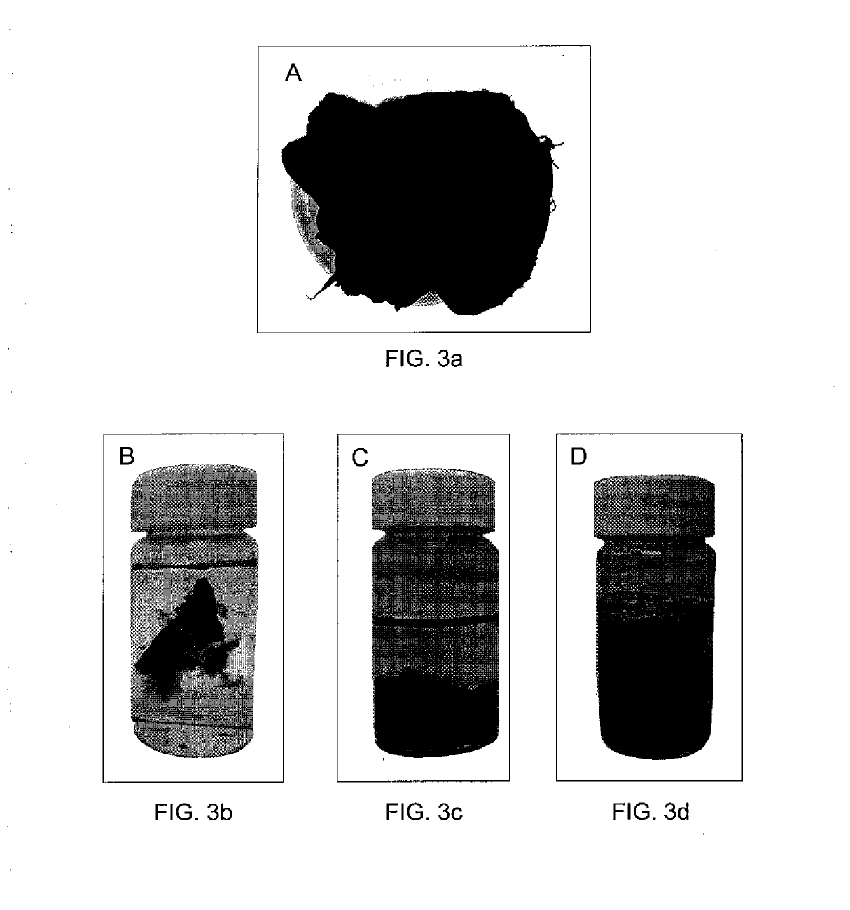

FIG. 2 is a digital photograph of the CNT dispersions prepared according to Comparative Example A (far left), the dispersion of the CNTs of Example A in water (middle), and the dispersion of the CNTs of Example A in propylene carbonate (far right). As shown in FIG. 2, the untreated DWNTs of the dispersion of Comparative Example A were so hydrophobic that they spontaneously sedimented out of the freshly prepared dispersion. FIG. 3d is a digital photograph of the CNT dispersion of Comparative Example B (i.e., the dispersion of untreated CNTs in PC). As shown in FIG. 3d, the same sedimentation of the CNTs out of the dispersion was observed in the dispersion of Comparative Example B made from untreated CNTs dispersed in propylene carbonate. In contrast, as also shown in FIG. 2, in the dispersions of the pretreated. DWNTs of Example A in water and in PC, the CNTs remain homogeneously dispersed in both samples. The pretreated CNTs of Example A remained homogeneously dispersed in the water and propylene carbonate solvents event after being allowed to stand without agitation or other interruption for an extended period of time (i.e., 5 days). These dispersions can remain stable (i.e., the CNTs can remain stably and homogeneously dispersed in solution without any significant sedimentation) for more than three months. Due to the organic nature of propylene carbonate as a solvent, a higher concentration of DWNTs can be reached with PC as a solvent as compared to water. However, pretreating the CNTs according to embodiments of the present invention enables high concentration dispersions of CNTs in water as well as propylene carbonate and other organic solvents.

The hydrophobicity of CNTs is affected by their length. In general, for example, the longer the CNTs, the more hydrophobic they are. Accordingly, achieving high concentrations of long CNTs in water and other solvents has proved quite challenging. However, using the pretreatment process according to embodiments of the present invention, high concentrations of long CNTs in water and other solvents can be realized. To confirm this, the following Comparative Examples C-F, and Examples D-F were prepared. These Comparative Examples C-F and Examples D-F are presented for illustrative purposes only, and do not limit the scope of the present invention.

### Comparative Example C

DWNTs were synthesized by floating catalyst chemical vapor deposition (FCCVD). The process yielded 350 mg/hr of DWNTs having a length of 1 mm to 5 mm. The FCCVD process used toluene and ferrocene as the carbon and catalyst source, respectively, and thiophene as the co-catalyst. The feeding rate was 0.15 ml/min. The temperature was 1050° C. to 1300° C. The reducing gas was H2 (0.5-2 slm), and the carrier gas was Ar/H2 (95/5-70/30, 6-10 slm).

### Comparative Example D

5 mg of the CNTs prepared according to Comparative Example C were added to 50 ml of water and the mixture was tip-sonicated for 45 minutes.

### Comparative Example E

5 mg of the CNTs prepared according to Comparative Example C were added to 50 ml of ethanol and the mixture was tip-sonicated for 45 minutes.

### Comparative Example F

5 mg of the CNTs prepared according to Comparative Example C were added to 50 ml of propylene carbonate and the mixture was tip-sonicated for 45 minutes.

### Example D

100 mg of the CNTs prepared according to Comparative Example C were first mixed with 150 ml of CHP and the mixture was tip-sonicated for about 30 minutes to obtain a CNT/CHP suspension. Next, the CNT/CHP suspension was mixed with 300 ml of 98% H₂SO₄. The mixture was heated at 85° C. and stirred with a magnetic stirrer for 24 hours. The resulting CNT solution was centrifuged and filtered to isolate the pretreated CNTs. Yield: greater than 95% of the starting CNTs. The isolated, pretreated CNTs were then added to water at a concentration of 0.1 mg/mL in 50 mg water and the mixture was tip-sonicated for 45 minutes.

### Example E

100 mg of the CNTs prepared according to Comparative Example C were first mixed with 150 ml of CHP and the mixture was tip-sonicated for about 30 minutes to obtain a CNT/CHP suspension. Next, the CNT/CHP suspension was mixed with 300 ml of 98% H₂SO₄. The mixture was heated at 85° C. and stirred with a magnetic stirrer for 24 hours. The resulting CNT solution was centrifuged and filtered to isolate the pretreated CNTs. Yield: greater than 95% of the starting CNTs. The isolated, pretreated CNTs were then added to ethanol at a concentration of 0.1 mg/ml in 50 mg of ethanol and the mixture was tip-sonicated for 45 minutes.

### Example F

100 mg of the CNTs prepared according to Comparative Example C were first mixed with 150 ml of CHP and the mixture was tip-sonicated for about 30 minutes to obtain a CNT/CHP suspension. Next, the CNT/CHP suspension was mixed with 300 ml of 98% H₂SO₄. The mixture was heated at 85° C. and stirred with a magnetic stirrer for 24 hours. The resulting CNT solution was centrifuged and filtered to isolate the pretreated CNTs. Yield: greater than 95% of the starting CNTs. The isolated, pretreated CNTs were then added to propylene carbonate at a concentration of 0.1 mg/ml in 50 mg of propylene carbonate and the mixture was tip-sonicated for 45 minutes.

FIG. 3a is a digital photograph of the DWNTs synthesized according to Comparative Example C. As can be seen in FIG. 3a, the nanotubes are tangled together and strongly adhered to each other, forming a cotton-like agglomerate. FIGS. 3b-d are digital photographs of the solutions prepared according to Comparative Examples D, E and F, respectively. As shown in FIGS. 3b-d, the untreated, long DWNTs prepared according to Comparative Example C do not disperse well in any of water, ethanol or propylene carbonate. Indeed, in the water dispersion of Comparative Example D, swelling of the skein can be observed. As can be seen in FIGS. 3b-d, the untreated, long nanotubes prepared according to Comparative Example C adhere to each other strongly, and are not detangled in water, ethanol or propylene carbonate (which are the most commonly used solvents for making CNT dispersions), even when aided by ultra-sonication.

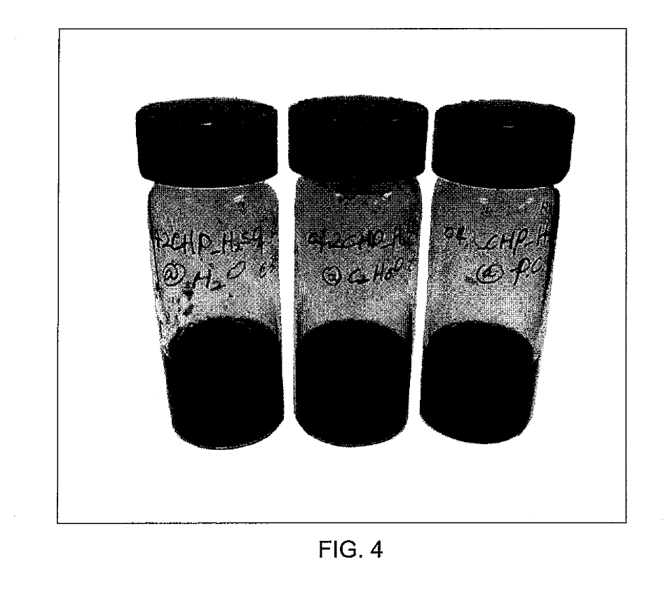

FIG. 4 is digital photograph of the solutions prepared according to Examples D (far left), E (middle) and F (far right). As shown in FIG. 4, the pretreated DWNTs disperse well in each of the solvents (i.e., water, ethanol and propylene carbonate). Additionally, as noted above, and shown in FIG. 4, the solution of pretreated DWNTs in PC achieved good dispersion at a high concentration of 0.5 mg/mL.

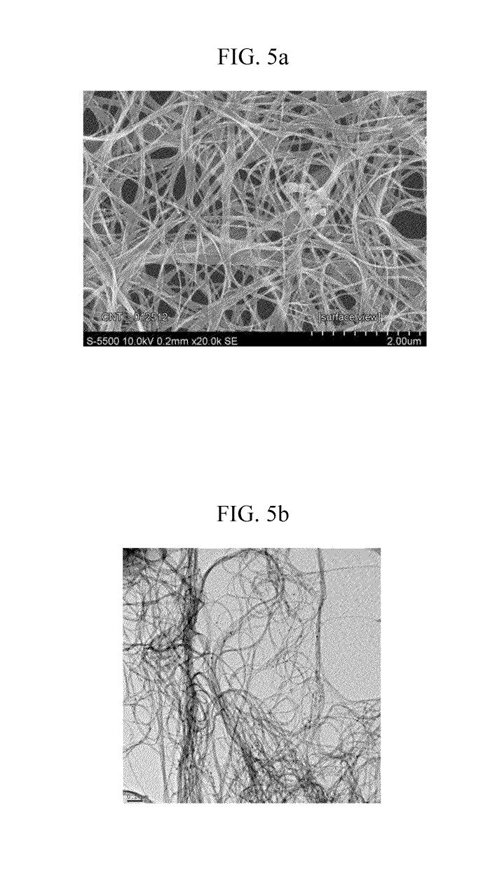

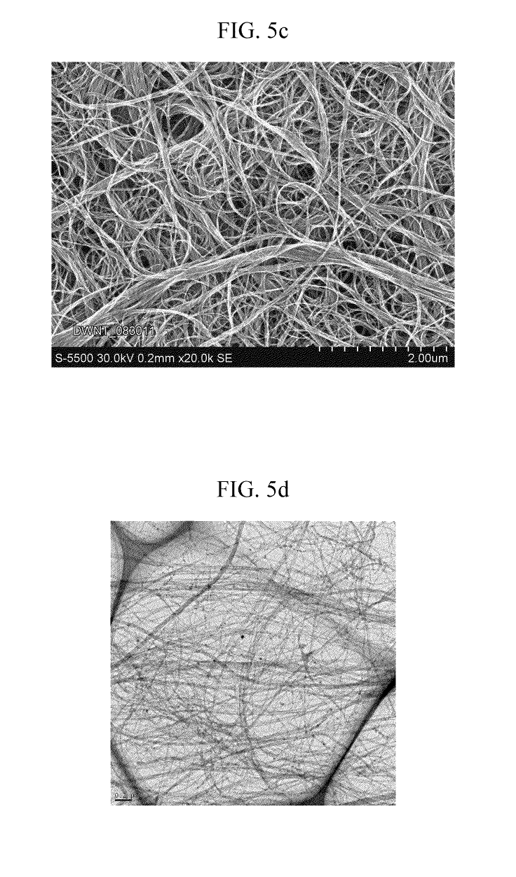

FIG. 5a is a scanning electron microscope (SEM) image of the DWNTs prepared according to Comparative Example C and pretreated according to Examples D, E and F but before dispersion in any solvent. FIG. 5b is a transmission electron microscope (TEM) image (right) of the DWNTs prepared according to Comparative Example C and pretreated according to Examples D, E and F but before dispersion in any solvent. The SEM and TEM images shown in FIGS. 5a and 5b confirm that the long nanotubes produced by the described FCCVD process maintain their length and thickness even after being subjected to the pretreatment process. In contrast, conventional chemical modification processes alter the n-conjugated structure of the carbon nanotubes themselves, making them susceptible to modification by radicals and/or certain oxidizing agents (such as, e.g., HNO₃, KMnO₄ and ozone), therefore compromising the unique properties of the carbon nanotubes, and often times causing them to break, thereby shortening their lengths. However, in embodiments of the present invention, concentrated H₂SO₄ (i.e., a relatively moderate oxidizing agent) is used, which selectively modifies the carbonaceous byproducts of the CNT manufacturing process, and generally does not chemically modify the CNTs themselves. As such, the CNTs do not break, thereby retaining their original lengths and thicknesses. FIG. 5c is a SEM image of the DWNTs prepared according to Comparative Example C (i.e., after FCCVD synthesis) but before pretreatment or dispersion, and FIG. 5d is a TEM image of the DWNTs prepared according to Comparative Example C (i.e., after FCCVD synthesis) but before pretreatment or dispersion. That the DWNTs are insignificantly damaged (or substantially undamaged) by the pretreatment process is further confirmed by the observance of smooth surfaces of the CNTs both before (FIGS. 5c and 5d) and after pretreatment (FIGS. 5a and 5b).

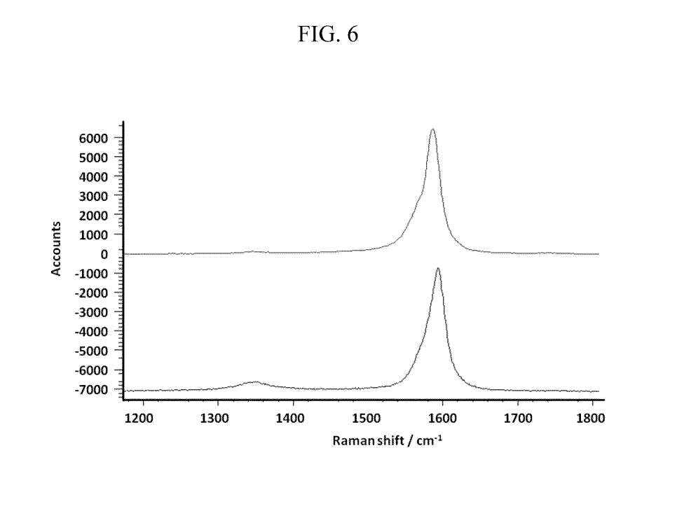

FIG. 6 is a graph comparing the Raman spectra of DWNTs obtained from CheapTubes, Inc. before (top spectrum) and after pretreatment according to the procedure outlined in Examples D-F but before dispersion in a solvent (bottom spectrum). As can be seen in FIG. 6, both curves exhibit a well-defined Raman response at about 1350 cm⁻¹ and at about 1580 cm⁻¹, which are characteristic of the D-band for sp³ carbon and G-band for graphitic structures, respectively. As can be seen in the Raman spectrum for the pretreated CNTs (i.e., the bottom curve), the relative intensity of the D-band versus the G-band (I_{D}/I_{G}) increases as a result of pretreatment. This increase in the relative intensity of the D-band versus the G-band (I_{D}/I_{G}) in addition to the Observations discussed above from the SEM and TEM images in FIGS. 5a and 5b confirm that the pretreatment modifies the carbonaceous byproducts of the CNT manufacturing process, and not the CNTs themselves.

Additionally, to confirm that the pretreatment process according to embodiments of the present invention preserves the characteristics (e.g., electrical conductivity characteristics) of the CNTs, the following Examples and Comparative Examples were performed. These Examples and Comparative Examples are presented for illustrative purposes only, and do not limit the scope of the present invention.

### Example G

### Thin Film Prepared Using Pretreated CNTs

A polyethylene terephthalate (PET) substrate was pre-conditioned by immersion in a water solution (0.5 wt % polyethyleneimine (PEI)) for 3 minutes, followed by washing with water and drying in air. Then, an aqueous stocking solution of the CNTs prepared according to Example A was prepared. The aqueous stocking solution included about 5 wt % sodium dodecylbenzenesulfonate (SDBS) and about 2 wt % poly(acrylic acid) sodium salt (PAAS). The concentration of CNTs in this stocking solution was 0.1 mg/ml. Large bundles of CNTs (if any) were removed from the aqueous solution by centrifugation at a rotating speed of 1000 rpm for 15 minutes. The prepared aqueous stocking solution was applied to the pre-conditioned PET substrate by bar-coating. After drying the coated substrate in air, the coated substrate was immersed in water to remove excess organics (e.g., surfactants and polymers). The thickness of the resulting CNT film was about 50 to about 100 nm.

### Comparative Example G

### Thin Film Prepared Using Untreated CNTs

A coated PET substrate was prepared as in Example G except that untreated CNTs prepared according to Comparative Example C were used instead of the pretreated CNTs prepared according to Example A. The thickness of the resulting CNT film was about 50 to about 100 nm.

The conductivity of the CNT films prepared according to each of Example G and Comparative Example G was measured using a four probe sensor (2440 5A Sourcemeter® from Keithley Instruments, Inc.). The conductivity of the thin film prepared according to Example G was 280Ω at a transmittance of 85% at 550 run, and the conductivity of the thin film prepared according to Comparative Example G was 450Ω at a transmittance of 73% (at 550 nm). The conductivity measurements are reported as an average value for several typical areas. As can be seen from a comparison of the measured conductivities, the conductivity of the thin film prepared using pretreated CNTs (Example G) is better than the conductivity of the thin film prepared using untreated CNTs (Comparative Example G). Indeed, because the pretreatment process does not damage or chemically modify the surface of the CNTs, the process does not significantly alter the CNT characteristics. The improved conductivity of the thin film can be attributed to the better dispersion of pretreated CNTs. In particular, because the pretreated CNTs are better dispersed in the solvent, the resulting thin firm will have smaller bundles of CNTs and more individual CNTs, resulting in improved conductivity of the resulting film. In contrast, untreated CNTs normally form large bundles, resulting in thin films with degraded electrical and optical performance.

CHP and CNTs have compatible Hansen solubility parameters, giving CHP a high affinity for CNTs. However, due to CHP's toxicity and high boiling point (i.e., greater than 150° C.), its use in carbon nanotube inks has been limited. When used with concentrated sulfuric acid in the pretreatment process according to embodiments of the present invention, however, the CHP and concentrated sulfuric acid work cooperatively to modify the surface of the CNTs selectively and efficiently. The CHP plays at least two roles in this pretreatment process. First, the CHP acts to efficiently disperse the CNTs (even long CNTs (e.g., 5 to 50 microns in length) and super long CNTs (e.g., greater than 1 mm in length)). Such well dispersed CNTs ensure that there is sufficient contact area available to take part in the sulfonation reaction. Second, the CHP catalyzes the sulfonation reaction by expediting proton exchange between H₂SO₄ molecules.

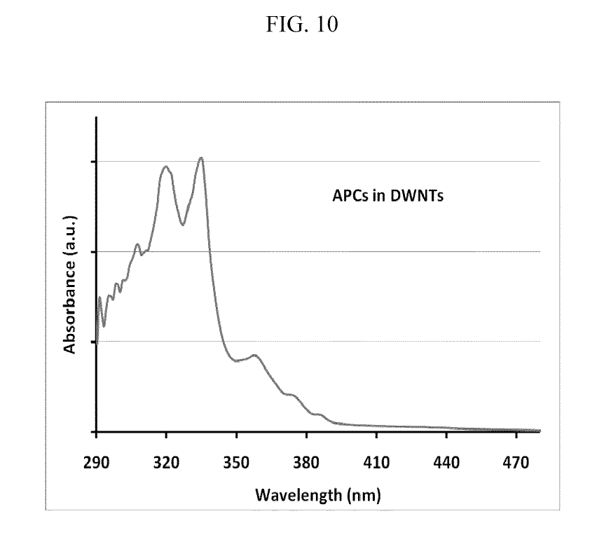

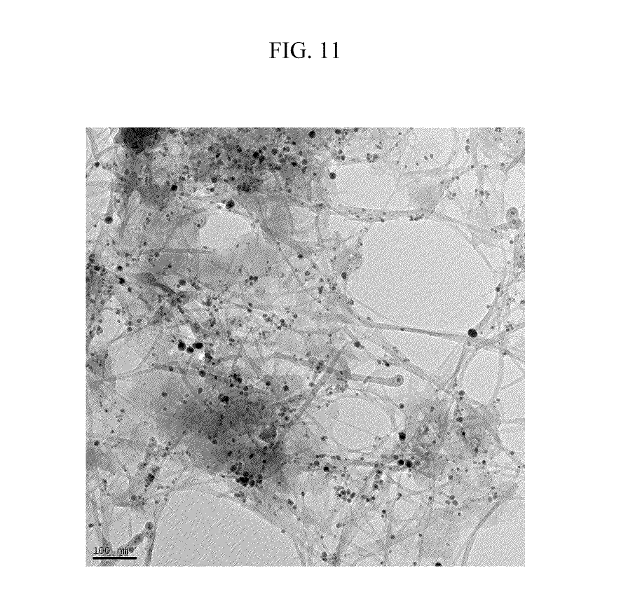

As noted above, the pretreatment process modifies the CNTs by functionalizing the aromatic polycyclic compounds on the surfaces of the carbon nanotubes. This selective surface modification of the APCs on the surfaces of the CNTs is quite different from other chemical modification processes in which the CNTs themselves are oxidized or attached to other moieties. The existence of APCs on the surfaces of commercially available CNTs was confirmed by isolation of the APCs from the CNTs, followed by structural analysis by gas chromatography-mass spectrometry (GC-MS), Raman spectroscopy, UV-vis spectroscopy, and transmission electron microscopy (TEM), as described in more detail below. The UV-vis spectrum is shown in FIG. 10, and the TEM image is shown in FIG. 11. In the TEM image, a significant amount of low crystallinity absorbates can be observed on the surfaces of the CNTs, confirming the existence of APCs on the surfaces of the CNTs.

To confirm selective surface modification of the APCs on the surfaces of the CNTs, CNT samples were purified by heating at 450° C. in air for 30 minutes to remove the APCs. The purified CNTs were then treated with the CHP/H₂SO₄ procedure described above, but no significant improvement in the dispersability of the CNTs was observed as a result of the pretreatment. This observation confirmed that the pretreatment process selectively modifies the APCs on the surfaces of the CNTs, rather than the CNTs themselves.

In long CNTs, it is believed that SO₃H⁻ attacks the terminal ring of the APC during the sulfonation reaction. The amount of surface modification can be adjusted according to the desired concentration of the CNT ink. To increase the amount of surface modification and increase the concentration of suspensions of the CNTs, a higher ratio of H₂SO₄ to CNTs may be used. On the other hand, the sulfonation process can be reversed by carbonizing the sulfo-aromatic compounds (which are the product of the sulfonation reaction) in concentrated H₂SO₄ at a temperature greater than 473 K. Such a reversal of the sulfonation reaction will lead to a reduced amount of surface modification, when desired. The selectivity of the surface modification and the reversal of the sulfonation reaction make the surface modification and dispersion concentration tunable. In contrast, such selective modification and tunability of modification is generally not possible using covalent modification or other mechanisms, and the modifications resulting from covalent mechanisms are not reversible.

H₂SO₄ is a relatively moderate oxidizing agent. As such, when used as part of the inventive pretreatment process, the H₂SO₄ minimally invades the CNTs. Indeed, when used as part of the inventive pretreatment process, the H₂SO₄ functionalizes the aromatic polycyclic compounds on the surfaces of the CNTs, but leaves the underlying structure of the CNTs intact. The inks or dispersions of CNTs pretreated by the inventive process are substantially free of contaminants that may significantly alter the nature of the CNTs, or detrimentally lower the performance of CNT-based devices. As used herein, the term “substantially” is used as a term of approximation, and not as a term of degree, and is intended to account for the inherent deviations in measured or calculated values that would be recognized by those of ordinary skill in the art. Accordingly, as used herein, the term “substantially free of contaminants” and similar terms mean that any contaminants exist in the ink in trace or negligible amounts.

According to embodiments of the present invention, the pretreatment process employs two commonly available chemical agents, i.e., CHP and concentrated H₂SO₄. As both of these chemicals generally do not chemically invade the underlying structure of the CNTs, the inventive pretreatment process is a substantially non-invasive, additive-free way to enhance the dispersibility of CNTs. As used herein, the term “generally” is used as a term of approximation, and not as a term of degree, and is intended to account for the inherent difficulty in measuring or calculating certain values. For example, as used herein, the phrase “generally does not chemically invade the underlying structure of the CNTs” and similar terms and phrases means that any invasion of the chemicals to the internal structure of the CNTs is minimal, trace or negligible.

Furthermore, the inventive CNT pretreatment process is simple, time and cost-effective, and efficient. Additionally, the process is easy to operate and control. Also, the process enables the efficient production of CNT dispersions in which the pretreated CNTs have physical and chemical properties that are substantially the same as their untreated counterparts (even when subjected to the pretreatment process for a long period of time). In one embodiment, for example, CNTs subjected to the pretreatment process for 70 hours have substantially the same physical and chemical properties as the CNTs prior to the pretreatment.

The pretreatment process according to embodiments of the present invention can be used to pretreat any CNTs, for example, short CNTs with lengths of a few microns (e.g., about 0.1 microns to about 5 microns, for example, about 3 μm) to long CNTs with lengths of several microns to several millimeters (e.g., about 30 microns to about 10 mm). Regardless of the length or type of CNTs (e.g., single walled, double walled, or multi-walled), the pretreatment process according to the present invention enables stable dispersion or suspension of the CNTs in various solvents without compromising or substantially affecting the length or conjugated structure of the CNTs.

Additionally, the pretreated carbon nanotubes according to embodiments of the present invention can be dispersed in various solvents (e.g., water and various organic solvents as discussed in more detail above) at high concentrations without the need for additional additives, surfactants, or polymers. The critical concentration of a CNT ink or dispersion for most industrial applications is 0.1 mg/ml. Historically, however, it has proved challenging to make a stable dispersion or suspension having this critical concentration. As used herein, the term “stable dispersion” and similar terms refers to a dispersion of CNTs in which the CNTs remain substantially dispersed in the solvent, and generally do not precipitate out of the solvent. However, the CNT dispersions according to embodiments of the present invention in which the CNTs are pretreated according to the above described pretreatment processes can achieve concentrations in various solvents that are even higher than the critical concentration of 0.1 mg/ml. Specifically, in some embodiments, dispersions of CNTs in water can reach concentrations as high as 0.3 mg/mL, and in other embodiments, dispersions of CNTs in propylene carbonate can reach concentrations as high as 0.5 mg/mL. Also, according to embodiments of the present invention, these high concentration dispersions can be achieved using either commercially available short CNTs (e.g., having a length of a few microns) or synthesized long CNTs (i.e., having a length of a few millimeters).

To confirm that the pretreatment process functionalizes aromatic polycyclic compounds on the surfaces of CNTs and does not modify the structure of the CNTs themselves, the following experiment (Example 1) was performed. However, Example 1 is presented for illustrative purposes only, and does not limit the scope of the present invention.

### Example 1

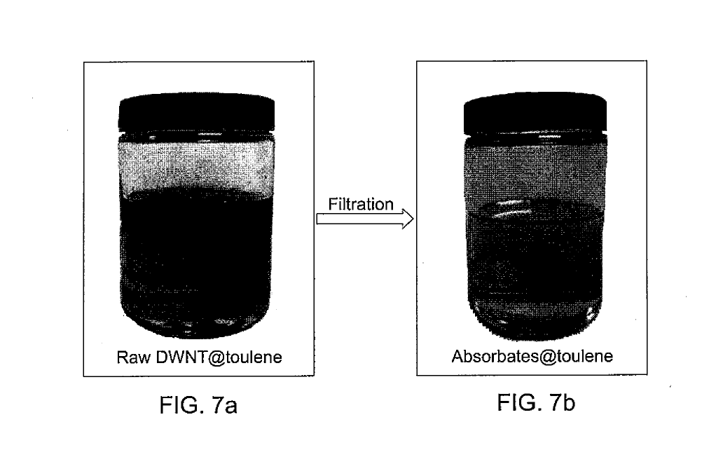

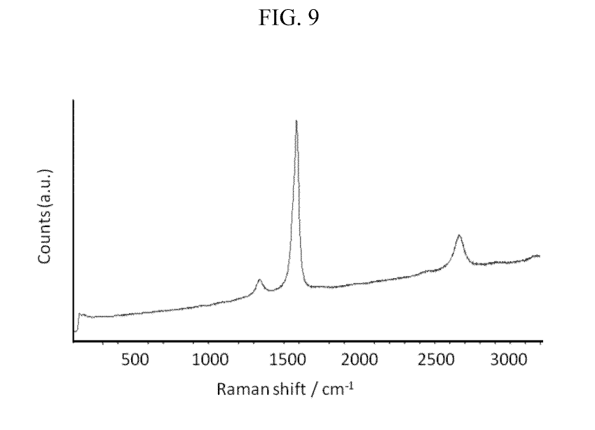

CNTs were synthesized by floating catalytic chemical vapor deposition (FCCVD) in which certain processing variables (e.g., temperature and duration) were selected to ensure incomplete pyrolysis, which resulted in the formation of a coating of aromatic compounds on the surfaces of the nanotubes. In particular, a feedstock solution was prepared by dissolving 0.5 to 2 wt % (e.g., 1 wt %) ferrocene (as the main catalyst) and 0.1 to 10 wt % (e.g., 0.15 wt %) thiophene (as a co-catalyst) in 97 to 99.4 wt % (e.g., 98.85 wt %) toluene. The FCCVD was conducted at a feeding rate of 0.15 ml/min and a temperature of 1050° C. to 1300° C. using H₂ (0.1 to 2 slm) as the reducing gas, and Ar/H₂ (95% Ar/5% H₂ to 70% Ar/30% H₂, 6 to 10 μm) as the carrier gas. The yield of sample can be 100 mg/hour to 350 mg/hour, for example 350 mg/hour under optimized conditions. The obtained sample was a carbon composite material including CNTs, carbonaceous species (i.e., amorphous carbon and polycyclic aromatic compounds), and iron nanoparticles. 300 mg of the obtained sample was immersed in 100 mL toluene and allowed to stand for 10 hours, after which the toluene changed to a dark green color (as shown in FIGS. 7a and 7b). The CNTs were then removed by filtration, and the filtrate solution was analyzed using gas chromatography-mass spectrometry (GC-MS) and Fourier Transform-InfraRed spectroscopy (FT-IR). The residue from the filtrate solution (i.e., the residue left after removal of the solvent from the filtrate solution) was also analyzed by TEM (shown in FIG. 11) and Raman spectroscopy (shown in FIG. 9). Also, FIG. 7a is a digital photograph of the synthesized CNTs in the toluene before filtration, and FIG. 7b is a digital photograph of the same solution after filtration. As shown in FIGS. 7a and 7b, the toluene changed color after immersion of the synthesized CNTs (i.e., the toluene changed from clear to green). This color change in the toluene solvent indicates a significant amount of organics in the synthetic CNT sample.

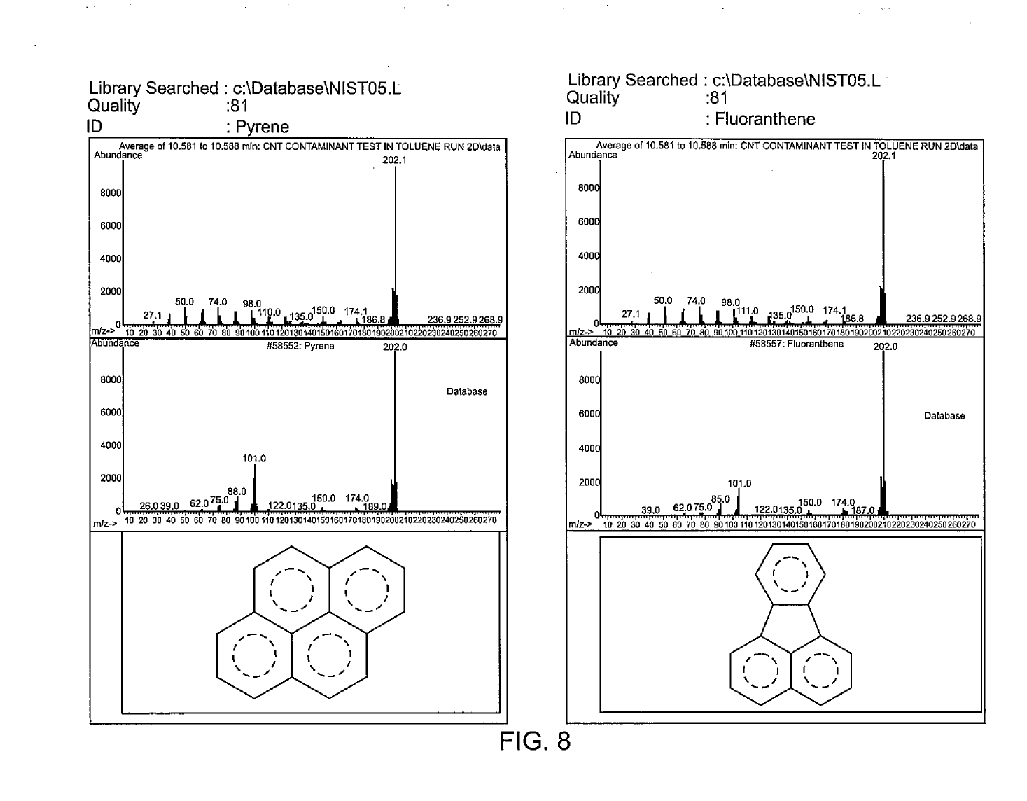

To further confirm the presence of organics in the synthesized sample, the filtrate was analyzed using GC-MS, and the spectrum is shown in FIG. 8 (top left and top right (identical spectra)). FIG. 8 also shows two known spectra of pyrene (bottom left) and fluoranthene (bottom right) from the GC-MS database. A comparison of the known spectra for pyrene and fluoranthene to the obtained spectrum for the filtrate solution indicates a match of greater than 81% based on identification of the primary peaks. This confirms the presence of polycyclic structures (i.e., pyrene and fluoranthene) in the synthesized CNTs.

After confirming the presence of organics in the filtrate, the toluene was removed from the filtrate by rotary vaporization. After removal of the toluene, the sample was analyzed using Raman spectroscopy. FIG. 9 is the Raman spectrum of the filtrate after toluene removal. As can be seen in the Raman spectrum of FIG. 9, the filtrate materials have highly conjugated π-stacking structures, confirming the presence of the polycyclic compounds identified by GC-MS (i.e., pyrene and fluoranthene). These structures can be readily sulfonated by heating in concentrated H₂SO₄ or H₂SO₄ fumes.

The results of the GC-MS and Raman spectroscopy confirm that the filtrate included carbonaceous materials with low crystallinity in addition to the CNTs. These carbonaceous materials, such as polycyclic compounds and amorphous carbon, can be selectively sulfonated by the inventive pretreatment process. The surface sulfonation reaction with the polycyclic compounds and/or amorphous carbon does not substantially change the nature of the CNTs themselves, but rather tethers the CNTs to hydrophilic —SO₃H groups by sulfonation of the polycyclic compounds and/or amorphous carbon at the surfaces of the CNTs. This sulfonation helps improve the dispersibility of the CNTs in various solvents, including water and most organic solvents.

To determine the mechanism by which the pretreatment process according to embodiments of the present invention improves the dispersibility of the CNTs, two experiments were conducted for comparison. These experiments are detailed below in Examples 2 and 3. However, these Examples are presented for illustrative purposes only, and do not limit the scope of the present invention.

### Example 2

CNTs were grown by FCCVD. The amount of polycyclic aromatic compounds (PAC) on the surfaces of the CNTs was controlled by adjusting certain parameters of the FCCVD growth process. In particular, the temperature was set at 1050° C., and the period of time allowed for growth of the CNTs was 4 hours. In particular, the FCCVD synthesis was conducted using 1 wt % ferrocene and 0.15 wt % thiophene in 98.85 wt % toluene at a feeding rate of 0.2 ml/min and a temperature of 1050° C. using H₂ (2 slm) as the reducing gas, and Ar/H₂ (85% Ar/15% H₂, 8 slm) as the carrier gas.

### Example 3

CNTs were grown as described in Example 2, and were purified (prior to being subjected to the pretreatment process according to embodiments of the present invention). The purification process included heat treatment in air at 400° C. for 1 hour to remove the amorphous carbon and polycyclic compounds, and washing in 1.0M HCl to remove the metal nanoparticles.

The CNTs prepared in both Examples 1 and 2 were subjected to the pretreatment process according to embodiments of the present invention. The pretreated CNTs according to Example 2 (i.e., with an increased amount of PACs on the surfaces of the CNTs) showed good dispersability. In contrast, the pretreated CNTs according to Example 3 (i.e., purified prior to pretreatment) showed no significant improvement in dispersibility compared to pristine CNTs (i.e., untreated, unpurified CNTs). These results indicate that the amount of carbonaceous species in general and polycyclic compounds in particular affects the dispersibility of the pretreated CNTs.

While certain exemplary embodiments of the present invention have been illustrated and described, it is understood by those of ordinary skill in the art that certain modifications and changes can be made to the described embodiments without departing from the spirit and scope of the present invention. Additionally, as used throughout this disclosure, the term “about,” and similar terms, is used as a term of approximation, not as a term of degree, and reflects the penumbra of variation associated with measurement, significant figures, and interchangeability, all as understood by a person having ordinary skill in the art to which this invention pertains.

What is claimed is:

1. A composition comprising:
carbon nanotubes; and
a functional group attached to an aromatic polycyclic compound on a surface of the carbon nanotubes.

2. The composition of claim 1, wherein the functional group is a —SO₃H functional group.

3. The composition according to claim 1, further comprising a solvent.

4. The composition according to claim 3, wherein the solvent comprises a solvent selected from the group consisting of water, ethanol, dimethylformamide, propylene carbonate, pyrrolidinone derivatives, and combinations thereof.

5. The composition according to claim 3, wherein the carbon nanotubes are suspended in the solvent at a concentration of about 0.1 mg/mL to about 10 mg/mL.

6. The composition according to claim 3, wherein the carbon nanotubes are suspended in the solvent at a concentration of about 0.1 mg/mL to about 0.3 mg/mL.

7. The composition according to claim 6, wherein the solvent comprises water.

8. The composition according to claim 3, wherein the carbon nanotubes are suspended in the solvent at a concentration of about 0.1 mg/mL to about 0.5 mg/mL.

9. The composition according to claim 8, wherein the solvent comprises ethanol or propylene carbonate.

10. A method of treating carbon nanotubes, the method comprising:
exposing the carbon nanotubes to a solvent selected from the group consisting of N-cyclohexyl-2-pyrrolidone, an analogue of N-cyclohexyl-2-pyrrolidone, N,N-dimethyl formamide, dimethyl sulfoxide, methylpyridine, tetrahydrofuran, and combinations thereof; and
exposing the carbon nanotubes to an acid selected from the group consisting of concentrated sulfuric acid, chlorosulfuric acid, oleum, and combinations thereof.

11. The method according to claim 10, wherein the analogue of N-cyclohexyl-2-pyrrolidone comprises a compound selected from the group consisting of dimethyl-tetrahydro-2-pyrimidinone, N-butyl-pyrrolidinone, benzyl-pyrrolidinone, N-methyl-pyrrolidinone, 3-(2-oxo-1-pyrrolidinyl)propanenitrile, N-ethyl-pyrrolidinone, N-octyl-pyrrolidinone, N-vinyl-pyrrolidinone, dimethyl-imidazolidinone, dimethyl-acetamide, N-dodecyl-pyrrolidone, and combinations thereof.

12. The method according to claim 10, wherein the exposing the carbon nanotubes to the solvent and the exposing the carbon nanotubes to the acid are performed in a single step, the single step comprising mixing the solvent, the acid and carbon nanotubes to form a carbon nanotube-solvent-acid solution.

13. The method according to claim 12, further comprising heating the carbon nanotube-solvent-acid solution.

14. The method according to claim 13, wherein the carbon nanotube-solvent-acid solution is heated at a temperature of about 50° C. to about 200° C.

15. The method according to claim 12, further comprising filtering the carbon nanotubes from the carbon-nanotube-solvent-acid solution.

16. The method according to claim 10, wherein the exposing the carbon nanotubes to the solvent comprises immersing the carbon nanotubes in the solvent to form a carbon nanotube-solvent immersion, and the exposing the carbon nanotubes to the acid comprises mixing the carbon nanotube-solvent immersion with the acid to form a carbon nanotube-solvent-acid solution.

17. The method according claim 16, further comprising heating the carbon nanotube-solvent immersion and/or the carbon nanotube-solvent-acid solution.

18. The method according to claim 17, wherein the carbon nanotube-solvent immersion and/or the carbon nanotube-solvent-acid solution is heated at a temperature of about 50° C. to about 200° C.

19. The method according to claim 16, further comprising filtering the carbon nanotubes from the carbon-nanotube-solvent-acid solution.
